(19) United States
(12) Patent Application Publication
(10) Pub. No.: US 2015/0363072 A1
(43) Pub. Date: Dec. 17, 2015

(54) SYSTEM, METHOD AND INTERFACE FOR VIEWER INTERACTION RELATIVE TO A 3D REPRESENTATION OF A VEHICLE

(71) Applicant: FOX SPORTS PRODUCTIONS, INC., Los Angeles, CA (US)

(72) Inventors: Zachary FIELDS, Woodland Hills, CA (US); Danny TELLO, Manhattan Beach, CA (US); Andy BLONDIN, Valencia, CA (US); Geoffrey K. HULL, Studio City, CA (US)

(73) Assignee: FOX SPORTS PRODUCTIONS, INC., Los Angeles, CA (US)

(21) Appl. No.: 14/760,017

(22) PCT Filed: Jan. 10, 2014
(86) PCT No.: PCT/US14/10976

§ 371 Date: Jul. 9, 2015

Related U.S. Application Data
(60) Provisional application No. 61/750,875, filed on Jan. 10, 2013.

(51) Int. Cl. G06F 3/0481; G06F 3/0484; G06F 3/147

(52) U.S. Cl. CPC G06F 3/04815; G06F 3/147; G06F 3/04842; G06F 3/04845

(57) ABSTRACT

A system, method and interface for viewer interaction relative to a 3D representation of a vehicle are provided including providing a viewer interface, presenting a 3D vehicle representation to a viewer, receiving input from a viewer via the viewer interface relative to a desired aspect or perspective of the vehicle, and adjusting or changing the 3D vehicle representation to correspond with the viewer indicated desired aspect or perspective.

### CROSS REFERENCE TO RELATED APPLICATION

The present application claims the benefit of U.S. Provisional Patent Application Ser. No. 61/750,875 filed Jan. 10, 2013, the entire contents of which are specifically incorporated by reference herein.

### TECHNICAL FIELD

The present invention is generally related to presentation of and interaction with a three dimensional (3D) representation of a vehicle.

### BACKGROUND OF THE INVENTION

Conventional information relative to vehicle components or configurations includes pre-rendered or pre-printed representations. In the case of presenting such information to a viewer, e.g., through a video broadcast by a commentator, the commentator must know exactly what the pre-rendered content is and must adhere to the constraints associated with pre-set content.

In certain related scenarios, the representations may not completely illustrate the desired discussion or topic. Accordingly, what is needed in the art is a mechanism that gives flexibility to a desired presentation of vehicle aspects or perspectives.

### SUMMARY OF THE INVENTION

The present system, method and interface for viewer interaction relative to a 3D representation of a vehicle overcomes and alleviates the problems and disadvantages of the prior art by providing a mechanism that is configured to permit a viewer to adjust a representation of a vehicle to a desired aspect or perspective.

In exemplary embodiments, the viewer may be any type of viewer, such as a broadcast commentator, a vehicle expert, or any other type of viewer, such as the end user of a computer interface, a user of a mobile device, etc. Further, the interface may be any type of interface, including interfaces used during a broadcast or other production, or a computer, tablet or mobile device interface that is configured with software or a network or internet connection to facilitate display of the presentation.

An exemplary method in accordance with the present disclosure includes providing a viewer interface, presenting a 3D vehicle representation to a viewer, receiving input from a viewer via the viewer interface relative to a desired aspect or perspective of the vehicle, and adjusting or changing the 3D vehicle representation to correspond with the viewer indicated desired aspect or perspective.

The above and other exemplary embodiments will be discussed in more detail below in the detailed description of the invention.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. In the FIGURES:

FIG. 1 is a flowchart illustrating an exemplary method in accordance with an exemplary embodiment of the invention;

FIG. 2 is an illustration of an exemplary presentation provided on a viewer display;

FIG. 3 is another illustration of an exemplary viewer interface provided on a viewer display;

FIG. 4 is an exemplary display showing an animation;

FIG. 5 is an illustration of an exemplary system for viewer interaction relative to a 3D representation of a vehicle;

FIG. 6 is an exemplary computer system and display diagram; and

FIG. 7 is an exemplary computer-usable medium in accordance with exemplary embodiments described herein.

### DETAILED DESCRIPTION OF THE INVENTION

Further to the brief description provided above and associated textual detail of each of the FIGURES, the following description provides additional details of example embodiments of the present invention. It should be understood, however, that there is no intent to limit example embodiments to the particular forms and particular details disclosed, but to the contrary, example embodiments are to cover all modifications, equivalents, and alternatives falling within the scope of example embodiments and claims Like numbers refer to like elements throughout the description of the FIGURES.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the FIGURES. For example, two FIGURES shown in succession, or steps illustrated within any given FIGURE, may in fact be executed substantially concurrently or may sometimes be executed in the reverse order, depending upon the functionality/acts involved.

Hereinafter, exemplary embodiments of the present invention are described in detail.

As we noted above, the present invention relates to a system, method and interface for viewer interaction relative to a 3D representation of a vehicle overcomes and alleviates the problems and disadvantages of the prior art by providing a mechanism that is configured to permit a viewer to adjust a representation of a vehicle to a desired aspect or perspective.

In exemplary embodiments, the viewer may be any type of viewer, such as a broadcast commentator, a vehicle expert, or any other type of viewer, such as the end user of a computer interface, a user of a mobile device, etc. Further, the interface may be any type of interface, including interfaces used during a broadcast or other production, or a computer, tablet or mobile device interface that is configured with software or a network or internet connection to facilitate display of the presentation.

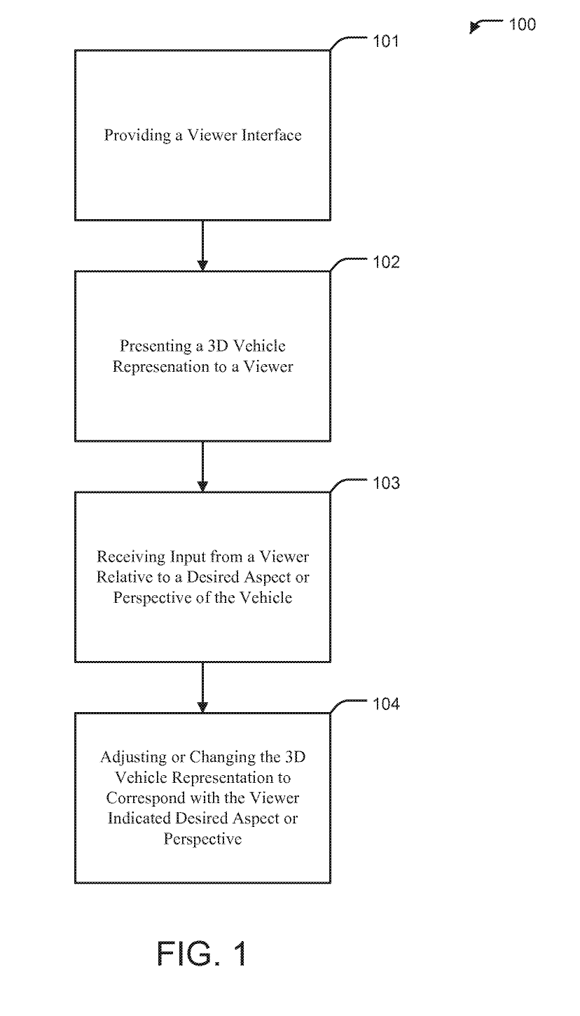

An exemplary method in accordance with the present disclosure is illustrated generally at 100 in FIG. 1, and includes providing a viewer interface(illustrated at block 101); presenting a 3D vehicle representation to a viewer (illustrated at block 102); receiving input from a viewer relative to a desired aspect or perspective of the vehicle(illustrated at block 103); and adjusting or changing the 3D vehicle representation to correspond with the viewer indicated desired aspect or perspective(illustrated at block 104).

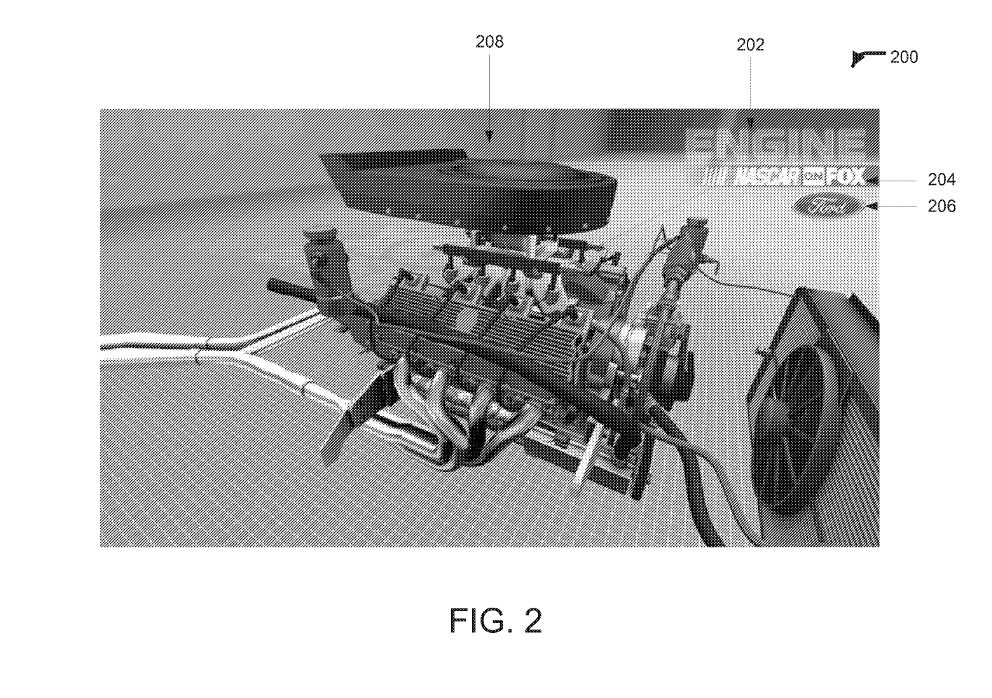

FIG. 2 illustrates an exemplary presentation (200) provided on a viewer display (not shown). This exemplary presentation identifies the vehicle component (identified here as “Engine” at 202), provides broadcast information (“NASCAR ON FOX” AT 204) and provides branding or advertising information (“Ford” at 206). The presentation also provides a 3D representation (either actual 3D or a 2D representation of the 3D object) of the engine itself (at 208).

In exemplary embodiments, controls for changing an aspect or perspective of the 3D representation may be provided via the interface itself (e.g., allowing swiping or multi-touch manipulation of the image), or such controls may be provided relative to but remote from the 3D representation (either separate from the 3D representation, but on the same device as the displayed representation, or on a separate device that has control over the 3D representation).

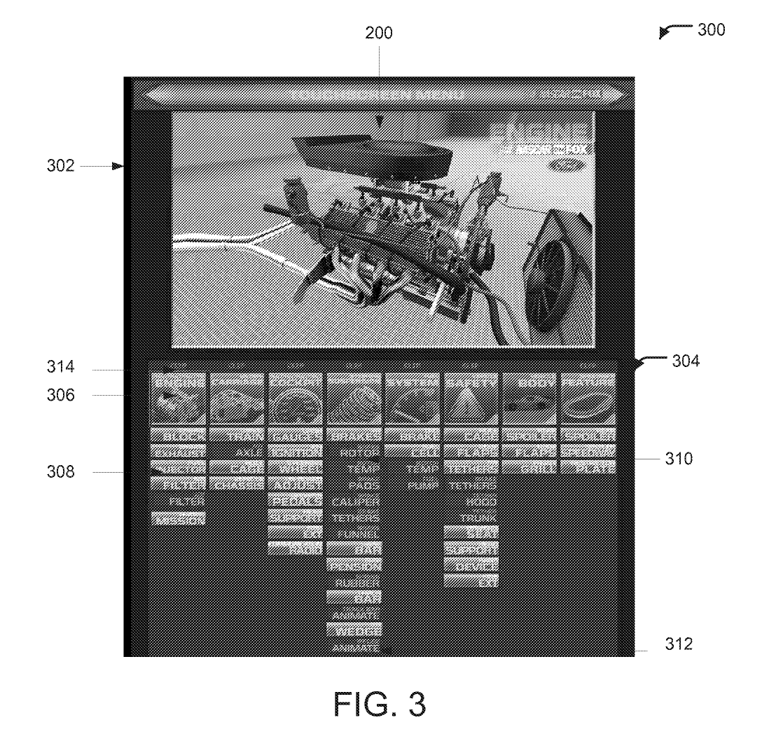

FIG. 3 illustrates an exemplary embodiment (shown generally at 300), wherein the presentation 200 is provided on a display 302 with a touchscreen menu (shown generally at 304). The illustrated exemplary touchscreen menu 304 includes various selectable vehicle categories (see, e.g., “Engine” at 306) and subcategories (see, e.g., “Injector” at 308). The controls may also provide selection of components in various states of assembly (to provide specific display of partially assembled or isolated components). For example, the illustrated “Brakes” category includes subcategories (illustrated generally at 310) that isolate or further display the rotor; the effects of temperature on the system, illustration of the brake pads; illustration of the calipers; illustration of the brake tethers and illustrations of the brake funnel. Further, any of the categories or subcategories may include full or partial animation to further illustrate components, e.g., including the track bar category, as well as an animate track bar tab, which is illustrated at 312.

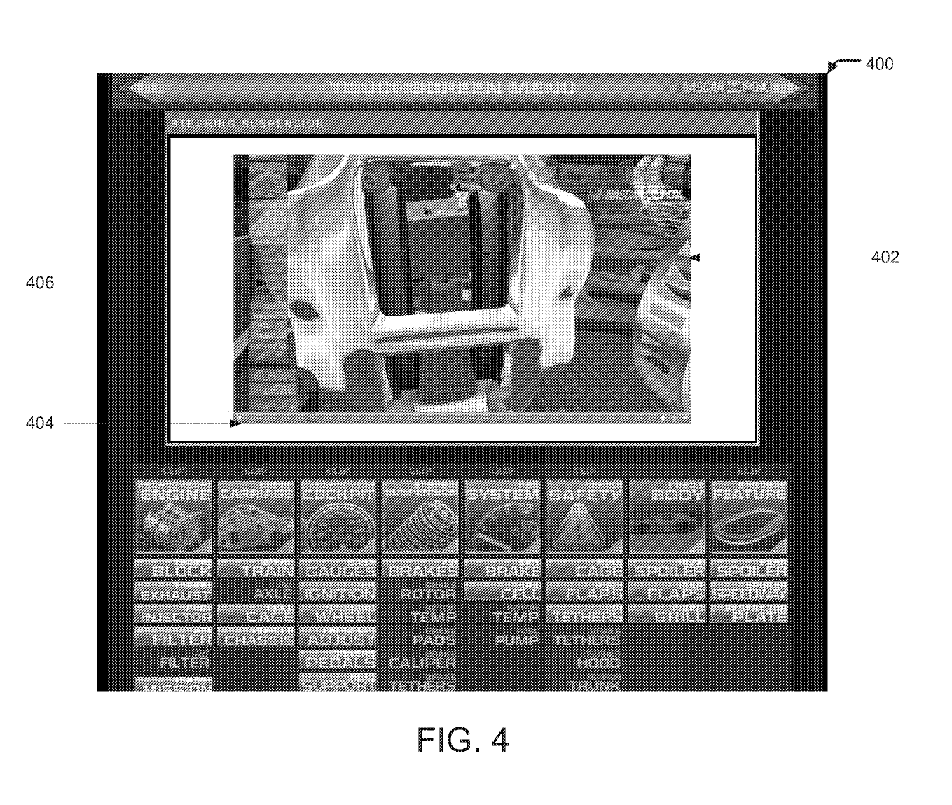

Further, the system may also implement controls that provide full component animations. One example of this is provided at 314, via the “clip” indicator above “Engine” 306. FIG. 4 illustrates an exemplary animation of the steering and suspension category, which in this case is displayed in a QuickTime window 402 provided on exemplary interface 400. Window 402 includes various play controls 404 and an indicator of the sequence of clip play 406 (in the illustrated exemplary embodiment, the video illustrates the brake calipers. In other exemplary embodiments, portions of the animation are selectable via touchscreen display, allowing manipulation of animation portion or perspective from such display.

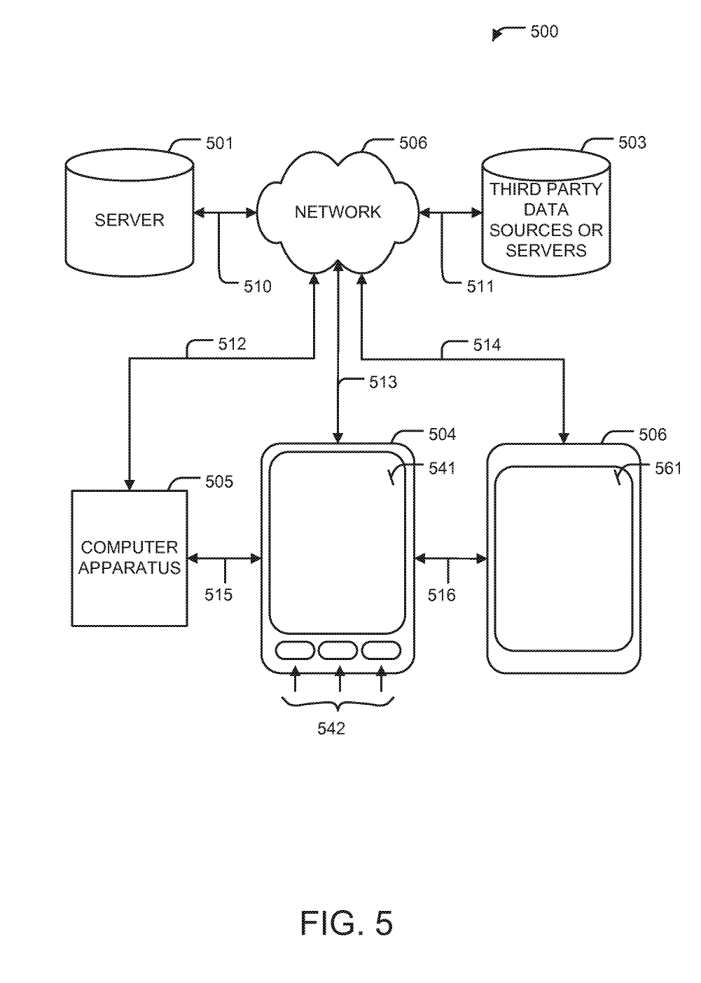

FIG. 5 illustrates an exemplary system for viewer interaction relative to a 3D representation of a vehicle. The system 500 may include a server 501. The server 501 may include a plurality of information, including but not limited to, vehicle information, schematics, reference images, 3D constructs, part isolations, expert analyses, advertisement information, algorithms and processing modules and other data storage. The server 501 may be in communication with a network 506 via a communication channel 510.

Additionally, the system 500 may access or interface with additional, third party data sources or servers 503. Third party sources of data 503 may be in communication with the network 506 via a communication channel 511. It is noted that although illustrated as separate, the source 503 may include a server substantially similar to server 501. The server 501 or source 503 may include a data service provider, for example, a cellular service provider, a business information provider, or any other suitable provider or repository. The server 501 or source 503 may also include an application server providing applications and/or computer executable code implementing any of the interfaces/methodologies described herein. The server 501 or source 503 may present a plurality of application defaults, choices, set-ups, and/or configurations such that a device may receive and process the application accordingly. The server 501 or source 503 may present any application on a viewer interface or web-browser of a device for relatively easy selection by a viewer of the device. The viewer interface or web-page rendered for application selection may be in the form of an application store and/or application marketplace.

Alternately, another server component or local computer apparatus, e.g., 504, 505 and/or 506, may produce the viewer interface and control connectivity to the server 501 or source 503. Also, the server 501 or one or more of the local computer apparatus 504, 505 and 506 may be configured to periodically access the source 503 and cache data relevant to data used in embodiments of the present invention.

The network 506 may be any suitable network, including the Internet, wide area network, and/or a local network. The server 501 and the source 503 may be in communication with the network 506 over communication channels 510, 511. The communication channels 510, 511 may be any suitable communication channels including wireless, satellite, wired, or otherwise.

An exemplary system 500 further includes computer apparatus 505 in communication with the network 506, over communication channel 512. The computer apparatus 505 may be any suitable computer apparatus including a personal computer (fixed location), a laptop or portable computer, a personal digital assistant, a cellular telephone, a portable tablet computer, a portable audio player, or otherwise. For example, the system 500 may include computer apparatuses 504 and 506, which are embodied as a portable cellular telephone and a tablet, respectively. The apparatuses 504 and 506 may include display means 541, 561, and/or buttons/controls 542. The controls 542 may operate independently or in combination with any of the controls noted above.

Further, the apparatuses 504, 505, and 506 may be in communication with each other over communication channels 515, 516 (for example, wired, wireless, Bluetooth channels, RF, etc); and may further be in communication with the network 506 over communication channels 512, 513, and 514.

Therefore, the apparatuses 504, 505, and 506 may all be in communication with one or both of the server 501 and the source 503, as well as each other. Each of the apparatuses may be in severable communication with the network 506 and each other, such that the apparatuses 504, 505, and 506 may be operated without constant communication with the network 506 (e.g., using data connection controls of an interface). For example, if there is no data availability or if a viewer directs an apparatus to work offline, the data used by any of the apparatuses 504, 505, and 506 may be based on stored or cached information/parameters. It follows that each of the apparatuses 504, 505, and 506 may be configured to perform the methodologies described in the various exemplary embodiments.

Furthermore, using any of the illustrated communication mediums, the apparatuses 504, 505, and 506 may manipulate, share, transmit, and/or receive different data previously or currently produced at any one of the illustrated elements of the system 500. For example, data may be available on the server 501 and/or the source 503. Moreover, viewers of any of the devices 504, 505, and 506 may independently manipulate, transmit, etc., data, e.g., to separately determine a current value of the index at a given time. Further, an interface providing a presentation and other information, such as is illustrated in FIGS. 2-4, may be provided by the server 501, an Internet site (not shown), or locally on any of the devices 504, 505 and 506 via appropriate software code.

In accordance with certain of the described exemplary embodiments, the present invention advantageously creates an environment wherein viewers can thoroughly explore 3D aspects of a vehicle. Embodiments that allow a viewer to navigate through aspects and perspectives of the vehicle provide a rich viewing experience. A particular, non-limiting example of such a system follows:

### Example 1

Reference is generally made to FIGS. 2-4 for non-limiting examples of interfaces in accordance with this particular, non-limiting example. This example provides a virtual cutaway car configured to allow an analyst to view the inside of almost any area of a NASCAR Cup Car and view it on a display, e.g., a 55 inch touchscreen. Such virtual cutaway car may be made by any appropriate software, including VIZ RT's realtime VIZ Artist software and Cinema 4D, among others, e.g., utilizing 3D artists working with reference images of a car, or otherwise.

In exemplary embodiments, the virtual cutaway car runs in real-time 3D without pre-rendered clips. In such mode, an analyst can view any desired part of the car in any sequence. Thus, an analyst can have a completely customizable rundown that has an infinite number of sequences.

Further, exemplary embodiments provide for isolated parts. Thus, if an analyst wants to see the air filter, all parts deem not necessary may be removed when the analyst dials into that area.

In other exemplary embodiments, an external control for the car may be provided by a tablet application. In such embodiment, an analyst can navigate to any area of the car in a manner similar to navigation via a (primary) touchscreen display. This may be done over WiFi connected to a router. Thus, in a broadcast production setting, one tablet may be positioned in the booth and one a studio truck (e.g., where a primary touchscreen display is positioned). Other embodiments allow for connection to the network via RF, so that broadcast personnel, analysts, etc. can be anywhere at the track and still control the virtual car (e.g., having an analyst 2 miles away on the other side of a race track, who is still controlling the virtual car in real time).

### Other Exemplary Embodiments

As we have noted in FIG. 2, certain interfaces may also include advertisement space, with advertisements served to users as a further source of revenue. Any interface contemplates such advertisements, including website interfaces, dedicated application interfaces, mobile device interfaces, broadcasted interfaces and interfaces at physical locations. Additionally, exemplary embodiments contemplate dedication of some or all of the advertisements to sponsors (e.g., a sponsor may take over the brand experience for an entire production or particular aspect or event).

Also, as we have noted above, exemplary embodiments of the present invention may be used in a broadcast production setting or otherwise, e.g., where a user interfaces the virtual car system from a home computer or device, among others.

Additionally and as described above, example embodiments of the invention may be embodied in the form of computer-implemented processes and apparatuses for practicing those processes. Therefore, according to an example embodiment, the methodologies described hereinbefore may be implemented by a computer system or apparatus. A computer system or apparatus may be somewhat similar to the mobile devices and computer apparatuses described above, which may include elements as described below.

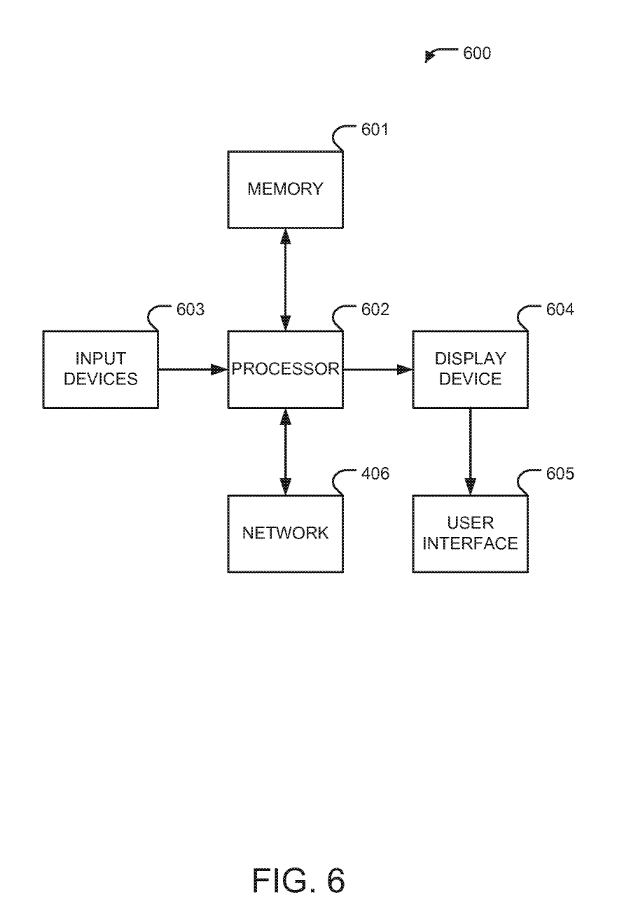

FIG. 6 illustrates a computer apparatus, according to an exemplary embodiment. Portions or the entirety of the methodologies described herein may be executed as instructions in a processor 602 of the computer system 600. The computer system 600 includes memory 601 for storage of instructions and information, input device(s) 603 for computer communication, and display device 604, which may display a user interface 605. The computer system 600 may further be connected to the network 406.

Thus, the present invention may be implemented, in software, for example, as any suitable computer program on a computer system somewhat similar to computer system 600. For example, a program in accordance with the present invention may be a computer program product causing a computer to execute the example methods described herein.

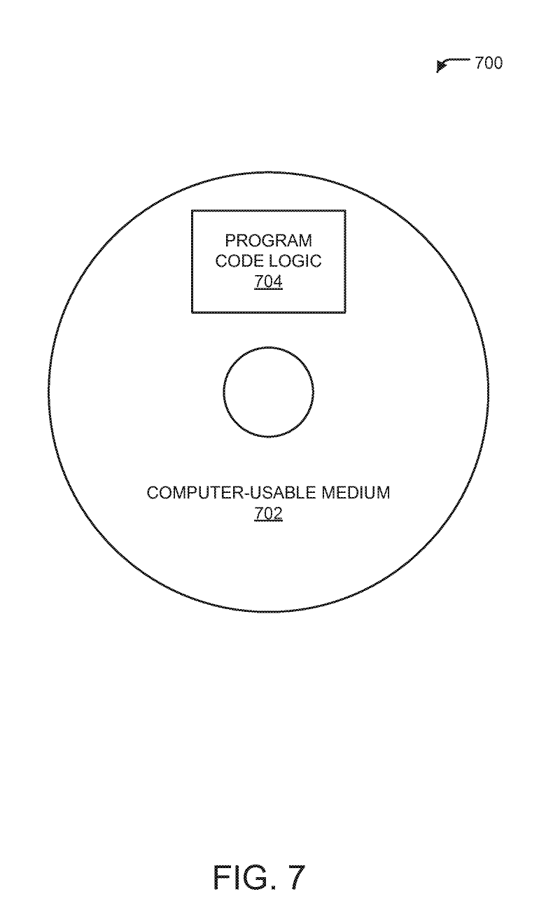

Therefore, embodiments can be embodied in the form of computer-implemented processes and apparatuses for practicing those processes on a computer program product. Embodiments include the computer program product 700 as depicted in FIG. 7 on a computer usable medium 702 with computer program code logic 704 containing instructions embodied in tangible media as an article of manufacture. Exemplary articles of manufacture for computer usable medium 702 may include floppy diskettes, CD-ROMs, hard drives, universal serial bus (USB) flash drives, or any other computer-readable storage medium, wherein, when the computer program code logic 704 is loaded into and executed by a computer, the computer becomes an apparatus for practicing the invention. Embodiments include computer program code logic 704, for example, whether stored in a storage medium, loaded into and/or executed by a computer, or transmitted over some transmission medium, such as over electrical wiring or cabling, through fiber optics, or via electromagnetic radiation, wherein, when the computer program code logic 704 is loaded into and executed by a computer, the computer becomes an apparatus for practicing the invention. When implemented on a general-purpose microprocessor, the computer program code logic 704 segments configure the microprocessor to create specific logic circuits.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the viewer's computer, partly on the viewer's computer, as a stand-alone software package, partly on the viewer's computer and partly on a remote computer or entirely on the remote computer or server. In the latter scenario, the remote computer may be connected to the viewer's computer through any type of network, including a local area network (LAN) or a wide area network (WAN), or the connection may be made to an external computer (for example, through the Internet using an Internet Service Provider).

As described above, features of example embodiments include and other unique features not found in the conventional art.

It should be emphasized that the above-described embodiments of the present invention, particularly, any detailed discussion of particular examples, are merely possible examples of implementations, and are set forth for a clear understanding of the principles of the invention. Many variations and modifications may be made to the above-described embodiment(s) of the invention without departing from the spirit and scope of the invention. All such modifications and variations are intended to be included herein within the scope of this disclosure and the present invention and protected by the following claims.

1. A method for viewer interaction relative to a 3D representation of a vehicle, comprising:
providing an interface to a viewer;
presenting a 3D vehicle representation to a viewer;
receiving input from a viewer relative to a desired aspect or perspective of the vehicle; and
adjusting or changing the 3D vehicle representation to correspond with the viewer indicated desired aspect or perspective.

2. A method in accordance with claim 1, wherein said presentation is a broadcast presentation, and wherein said input from a viewer is input from a broadcast personnel

3. A method in accordance with claim 2, wherein said presentation comprises manipulation of a virtual 3D car by a broadcast analyst.

4. A method in accordance with claim 3, wherein said presentation further comprises selection of a vehicle component and manipulation of a vehicle component displayed aspect by said analyst for broadcast.

5. A method in accordance with claim 1, wherein said interface comprises a touchscreen display interface.

6. A method in accordance with claim 1, wherein said interface comprises a mobile device interface.

7. A method in accordance with claim 1, wherein said interface comprises a web interface.

8. A method in accordance with claim 4, wherein said interface comprises a touchscreen display at a first interface and a mobile interface at a second location.

9. A method in accordance with claim 8, wherein said interface comprises a production broadcast display screen and at least one remote mobile device configured to control the production broadcast display screen.

10. A method in accordance with claim 1, wherein said display is a touchscreen display that is configured with a populated index of selectable categories and subcategories corresponding to vehicle aspects and components.

11. A method in accordance with claim 10, wherein said display further includes at least selectable animation of a vehicle aspect or component.

12. A system for viewer interaction relative to a 3D representation of a vehicle, comprising:
a viewer interface, the viewer interface configured to present a 3D vehicle representation to a viewer as a presentation;
a control input configured to permit a viewer to select a desired aspect or perspective of the vehicle; and
a server configured to adjust or change the 3D vehicle representation to correspond with the viewer indicated desired aspect or perspective, wherein the server accesses storage containing 3D vehicle information corresponding to said desired aspect or perspective.

13. A system in accordance with claim 12, wherein said presentation is a broadcast presentation, and wherein said input from a viewer is input from a broadcast personnel

14. A system in accordance with claim 13, wherein said presentation comprises manipulation of a virtual 3D car by a broadcast analyst.

15. A system in accordance with claim 14, wherein said presentation further comprises selection of a vehicle component and manipulation of a vehicle component displayed aspect by said analyst for broadcast.

16. A system in accordance with claim 12, wherein said interface comprises a touchscreen display interface.

17. A system in accordance with claim 12, wherein said interface comprises a mobile device interface.

18. A system in accordance with claim 12, wherein said interface comprises a web interface.

19. A system in accordance with claim 15, wherein said interface comprises a touchscreen display at a first interface and a mobile interface at a second location.

20. A system in accordance with claim 19, wherein said interface comprises a production broadcast display screen and at least one remote mobile device configured to control the production broadcast display screen.

21. A system in accordance with claim 12, wherein said display is a touchscreen display that is configured with a populated index of selectable categories and subcategories corresponding to vehicle aspects and components.

22. A system in accordance with claim 21, wherein said display further includes at least selectable animation of a vehicle aspect or component.
